(19) United States
(12) Patent Application Publication
(10) Pub. No.: US 2015/0123331 A1
(43) Pub. Date: May 7, 2015

(54) Set of nested cutting boards

(71) Applicant: Agostino Difante, San Clemente, CA (US)

(72) Inventor: Agostino Difante, San Clemente, CA (US)

(21) Appl. No.: 13/998,509

(22) Filed: Nov. 6, 2013

(51) Int. Cl. A47J 47/00

(52) U.S. Cl. CPC A47J 47/005; A47J 2201/00
USPC 269/9

(57) ABSTRACT

An efficient and economical cutting board used for chopping foods that puts multiple cutting boards at your fingertips, is easily stored, and helps prevent cross contamination of food is very useful in the kitchen. A versatile cutting board that has multiple cutting boards nested together, takes up no more space than the largest cutting board and when placed on the countertop the other cutting boards are hidden and not visible.

### BACKGROUND

The background of the invention will be discussed in two parts.

1. Field of Invention

The present invention relates in general to a set of cutting boards that nest and fit together providing a set of boards that take up the same amount of space as one board, and allowing you to have more than one cutting board available at your fingertips to prevent cross contamination of food.

2. Prior Art

When working in a kitchen there has always been a need to have easily available different cutting boards as needed to allow for eliminating the risk of cross contamination of food. Prior art is inefficient and has many deficiencies. In order to use more than one cutting board you have to store additional boards in the cupboard. It is the object of this invention to provide a cutting board that is simple to use, easy to store, and economical to make. A cutting board that allows the user to have more than one cutting board at his fingertips. A cutting board that does not take up any more space in the kitchen than one cutting board. Other objects of the invention will become apparent with the reading of the specification taken with the drawings wherein there is shown and described the apparatus of the invention.

### SUMMARY

It is a feature of the present invention to provide a new set of cutting boards that nest and fit together providing the user a set of boards available to be used as needed preventing cross contamination of food. A cutting board that is more easy to use, takes up the same amount of space as one cutting board, is more efficient, and more flexible in its uses.

### BRIEF DESCRIPTION OF THE DRAWINGS

FIG. 1 is an exploded perspective view showing the multiple cutting boards.

FIG. 2 is a perspective view of the bottom of the multiple cutting boards nested together.

FIG. 3 is a sectional view of the multiple boards nested together.

FIG. 4 is an front elevation of the primary cutting board and also a front elevation of the set of nested cutting boards. The rear elevation being a mirror image thereof.

FIG. 5 is an right side elevation of the primary cutting board and also a right side elevation of the set of nested cutting boards. The left side elevation being a mirror image thereof.

FIG. 6 is a top plan view of the primary cutting board and also a top plan view of the set of nested cutting boards.

FIG. 7 is a bottom plan view of the primary cutting board. Here is more clearly shown the hollowed out area to allow for the secondary cutting board.

FIG. 8 is a bottom plan view of the nested cutting boards. Here is more clearly shown how the multiple boards nest and fit within each other.

FIG. 9 is a front elevation of the secondary cutting board and also a front elevation of the set of the secondary and tertiary cutting boards nested together. The rear elevation being a mirror image thereof.

FIG. 10 is right side elevation of the secondary cutting board and also a side elevation of the set of the secondary and tertiary cutting boards nested together. The left side elevation being a mirror image thereof.

FIG. 11 is top plan view of the secondary cutting board and also a top plan view of the set of the secondary and tertiary cutting boards nested together.

FIG. 12 is a bottom plan view of the secondary cutting board. Here is more clearly shown the hollowed out area to allow for the tertiary cutting board.

FIG. 13 is a front elevation of the tertiary cutting board. The rear elevation being a mirror image thereof.

FIG. 14 is a right side elevation of the tertiary cutting board. The left side elevation being a mirror image thereof.

FIG. 15 is a top plan view of the tertiary cutting board.

FIG. 16 is a bottom plan view of the tertiary cutting board. Here is more clearly seen how the tertiary board is like a regular cutting board and does not have a hollowed out area.

### DETAILED DESCRIPTION OF THE DRAWINGS

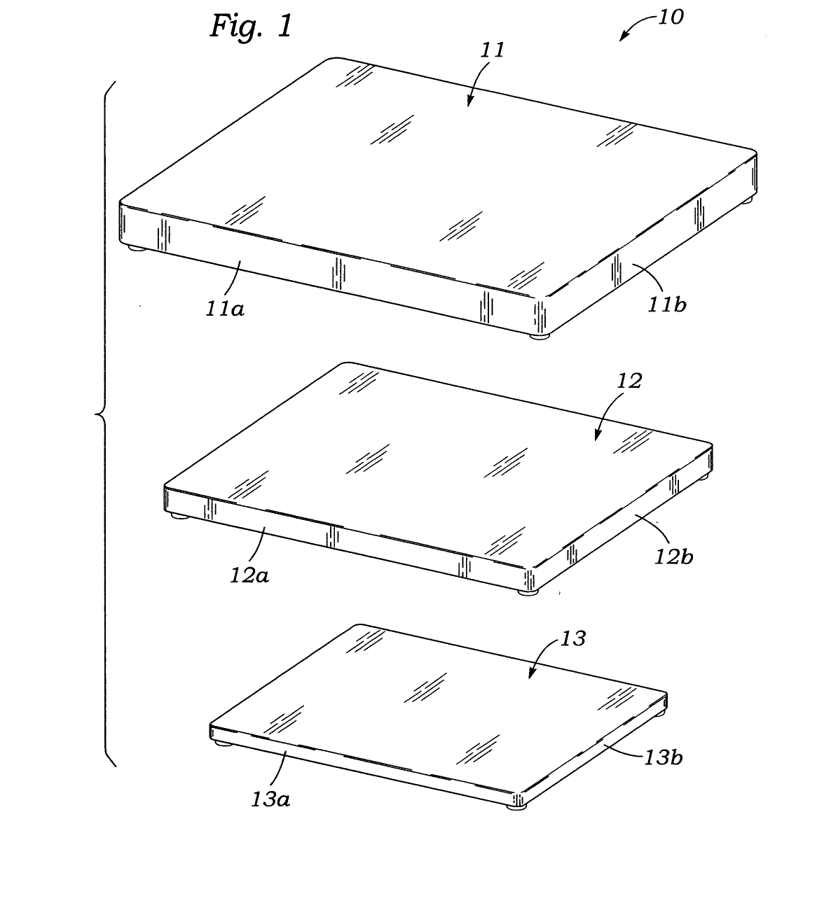

FIG. 1 is an exploded perspective view of the showing multiple cutting boards generally designated 10. In this view it is shown how the primary cutting board 11 is the largest board, the secondary medium sized cutting board 12 is slightly smaller, and the tertiary cutting board 13 is the smallest board.

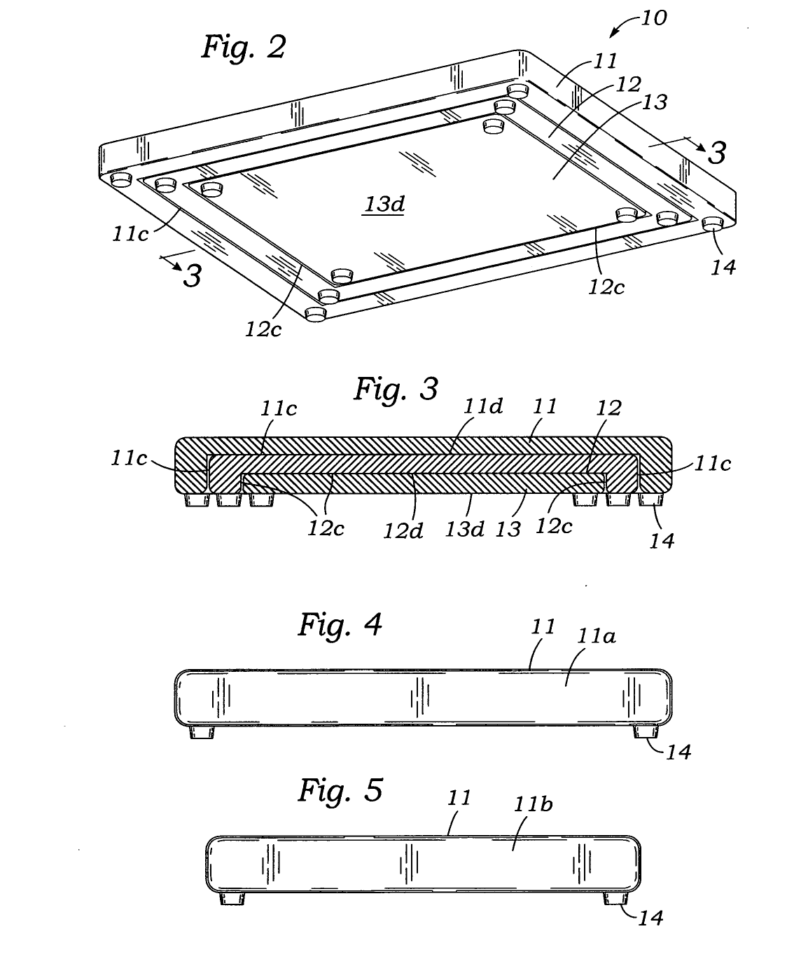

FIG. 2 is a perspective view showing the bottom of the set of nested cutting boards generally designated 10. Here is more clearly shown how the hollowed out area within the primary cutting board 11 designated 11c and 11d in FIG. 3 is substantially large enough to allow the secondary cutting board 12 to fit within that hollowed out area. Also is more clearly shown how the hollowed out area within the secondary cutting board 12 designated 12c and 12d in FIG. 3 is substantially large enough to allow the tertiary cutting board 13 to fit within that hollowed out area. Lastly is shown the optional bumper pads 14 under each board to help prevent movement of the boards and help allow air to circulate under the boards.

FIG. 3 is a sectional view of the set of nested cutting boards generally designated 10. Here is shown the larges primary board 11, housing the secondary medium sized board 12 within the hollowed out area 11c and 11d, and the secondary board 12 housing the tertiary smallest board 13 within the hollowed out area 12c and 12d.

FIG. 4 is a front elevation 11a of the primary board 11 and also a front elevation of the set of nested boards generally designated 10. Here is more clearly shown how the nested secondary and tertiary boards are not visible. The rear elevation being a mirror image thereof. Also shown are the optional bumper pads 14.

FIG. 5 is a right side elevation 11b of the primary board 11 and also a right side elevation of the set of nested boards generally designated 10. Here is more clearly shown how the nested secondary and tertiary boards are not visible. The left side elevation being a mirror image thereof.

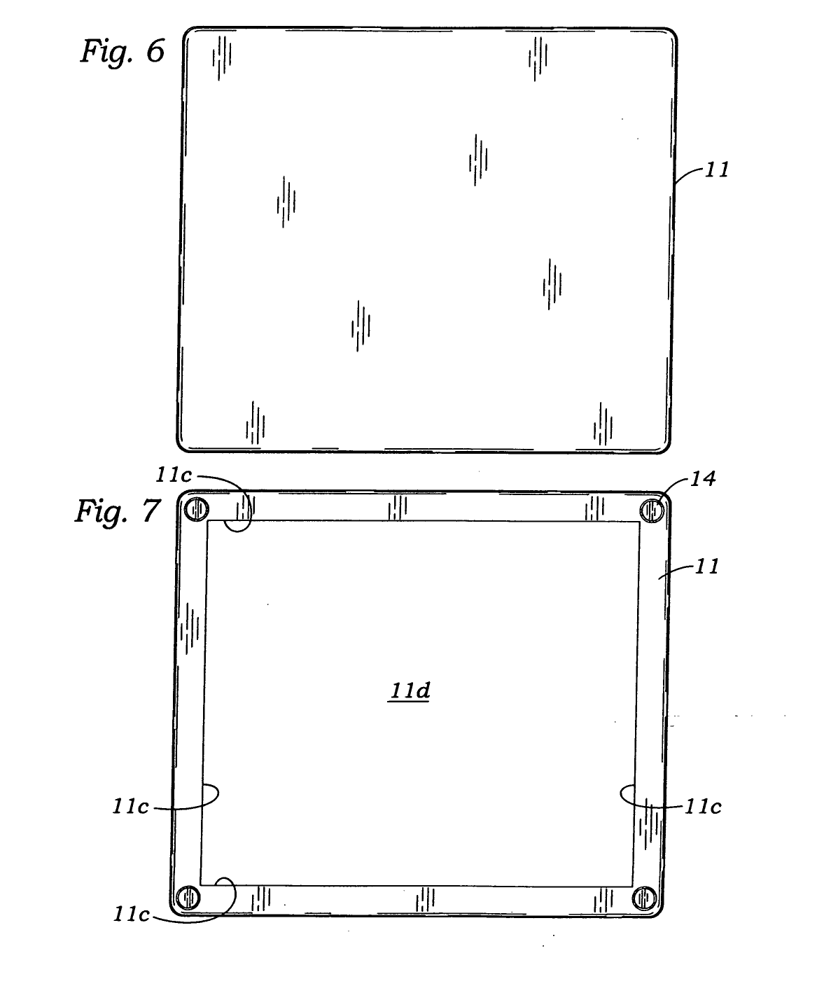

FIG. 6 is a top plan view of the primary board 11 and also a top plan view of the set of nested boards generally designated 10. Here is more clearly shown how the nested secondary and tertiary boards are not visible.

FIG. 7 is a bottom plan view of the largest primary cutting board 11. Here is more clearly shown the hollowed out area 11c and 11d allow the secondary board 12 to be inserted within this hollowed out area. Also shown are the optional bumper pads 14 which help to prevent movement of the board and to allow for air circulation under the boards.

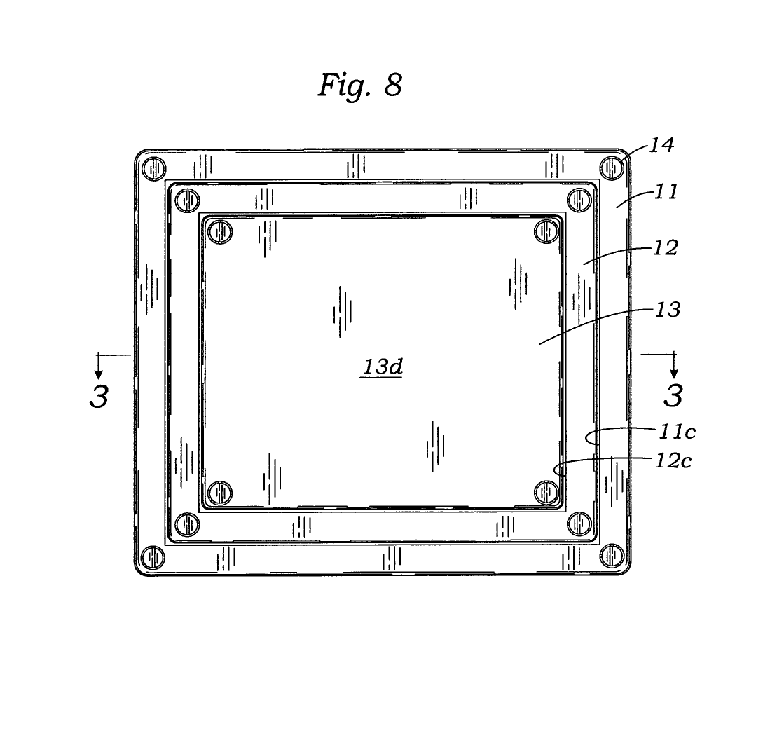

FIG. 8 is a bottom plan view of the set of nested cutting boards generally designated 10. Here is more clearly shown how the hollowed out area within the primary cutting board 11 designated 11c and also designated in FIG. 7 as 11d is substantially large enough to allow the secondary board 12 to fit within that hollowed out area. Also is more clearly shown how the hollowed out area within the secondary cutting board 12 designated 12c and also designated in FIG. 12 as 12d is substantially large enough to allow the tertiary cutting board 13 to fit within that hollowed out area.

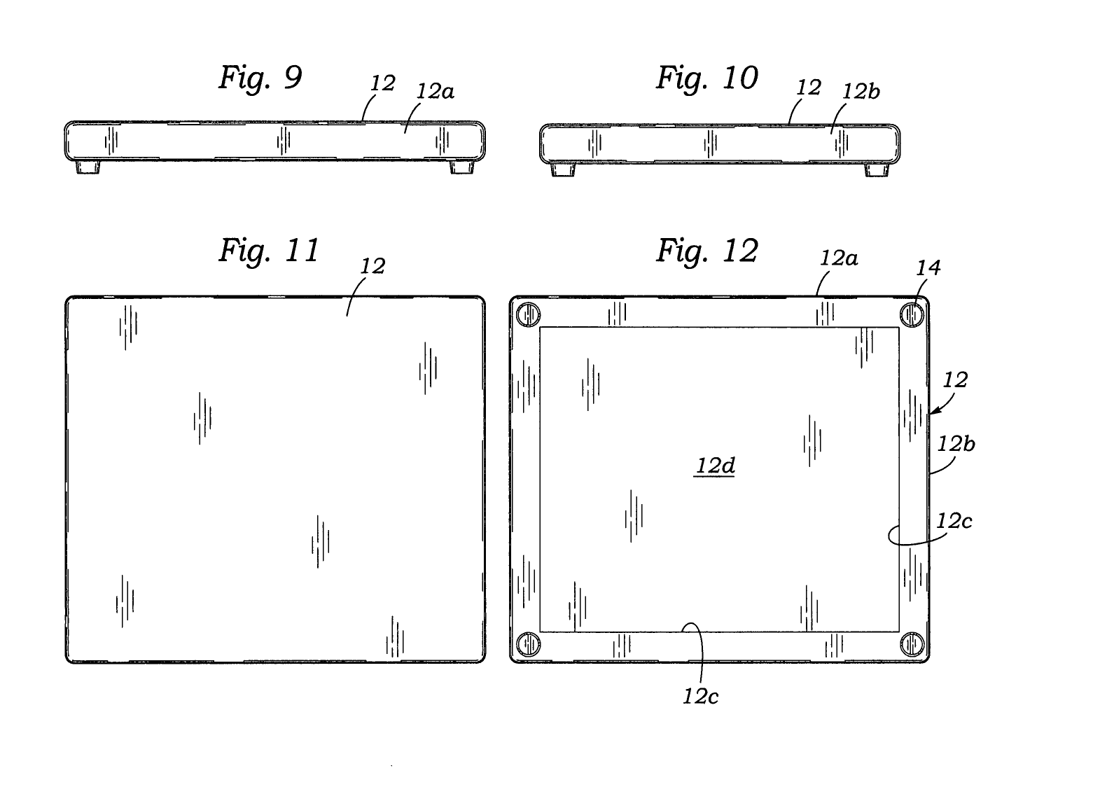

FIG. 9 is a front elevation of the medium sized secondary cutting board 12 and also an elevation of the nested tertiary cutting board 13 within the secondary cutting board 12. The rear elevation being a mirror image thereof. Also shown are the optional bumper pads 14 to help prevent movement and to raise the board above the table surface and allow air circulation. Here is more clearly shown how the tertiary cutting board 13 when nested within cutting board 12 is not visible.

FIG. 10 is a right side elevation of the medium sized cutting board 12 and also an elevation of the nested tertiary cutting board 13 within the secondary cutting board 12. The left side elevation being a mirror image thereof. Also shown are the optional bumper pads 14 to help prevent movement and to raise the board above the table surface and allow air circulation. Here is more clearly shown how the tertiary cutting board 13 when nested within cutting board 12 is not visible.

FIG. 11 is a top plan view of the medium sized cutting board 12 and also a top plan view of the tertiary cutting board 13 nested within the secondary cutting board 12. Here is more clearly shown how the tertiary cutting board 13 when nested within the cutting board 12 is not visible.

FIG. 12 is a bottom plan view of the medium sized cutting board 12. Here is more clearly shown the area 12c and 12d hollowed out to allow for the smallest cutting board 13 to fit within the hollowed out area.

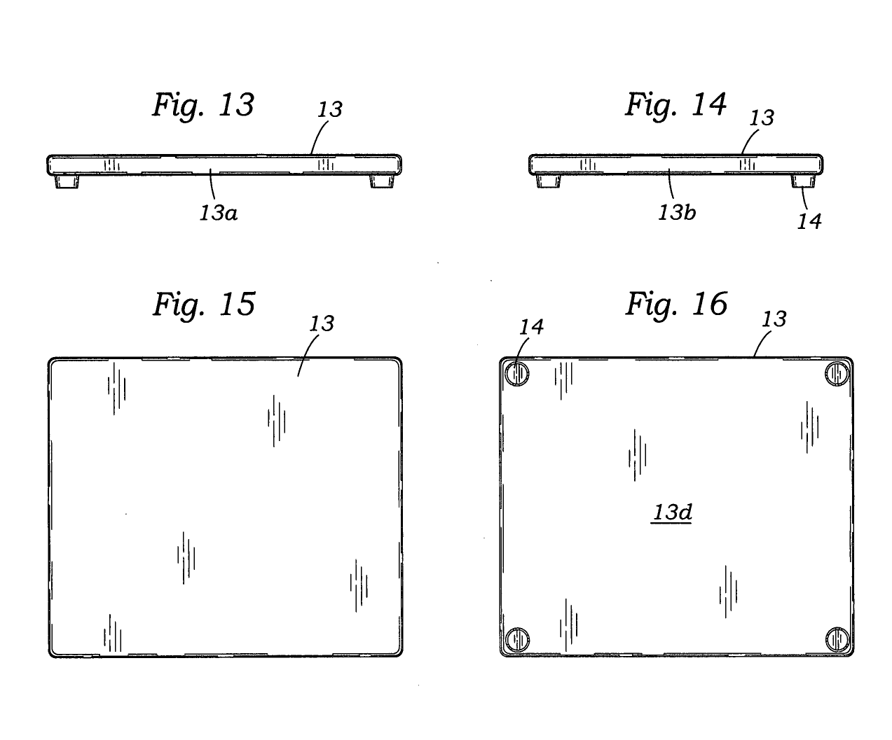

FIG. 13 is a front elevation of the smallest tertiary cutting board 13. The rear elevation being a mirror image thereof. Also shown are the optional bumper pads 14 to help prevent movement and to raise the board above the table surface and allow air circulation. Here is more clearly shown how the smallest cutting board 13 is a regular cutting board.

FIG. 14 is a right side elevation of the smallest cutting board 13. The left side elevation being a mirror image thereof. Also shown are the optional bumper pads 14 to help prevent movement and to raise the board above the table surface and allow air circulation. Here is more clearly shown how the smallest cutting board 13 is a regular cutting board.

FIG. 15 is a top plan view of the smallest cutting board 13.

FIG. 16 is a bottom plan view of the smallest cutting board 13 designated 13d. Here is more clearly shown that this cutting board is not hollowed out. The option is available to hollow out this board and make room for an additional board if desired.

While the principles of the invention have been described and illustrated in a single embodiment, it will be obvious to those skilled in the art that many modifications of structure, shape, materials, and components used in the practice of the invention can be particularly adapted for specific operating requirements without departing from these principles.

What is claimed is:

1. A set of cutting boards comprising:
a multiplicity of cutting boards nested together;
a large primary cutting board;
a secondary medium sized cutting board capable of being nested within a cavity in the primary cutting board;
a tertiary smallest cutting board capable of being nested within a cavity in the said secondary cutting board;
said primary cutting board configured to allow said secondary cutting board to be inserted within a cavity in said primary cutting board and said secondary cutting board configured to allow a tertiary cutting board to be inserted within a cavity in said secondary cutting board;
said primary cutting board configured to allow said secondary cutting board including said tertiary cutting board inclusively inserted into a cavity within said primary cutting board.

2. The set of nested cutting board of claim 1 wherein:
said tertiary cutting board is inserted into a cavity in the said secondary cutting board and said tertiary and secondary cutting boards are inclusively inserted into a cavity in the said primary cutting board;

3. The set of nested cutting board of claim 1 wherein:
said primary cutting board is substantially hollowed out to allow the said secondary cutting board to fit within and under said hollowed out area

4. The set of nested cutting board of claim 1 wherein:
said secondary cutting board is substantially hollowed out to allow the said tertiary cutting board to fit within and under said hollowed out area;

5. The set of nested cutting boards of claim 1 wherein:
said secondary and said tertiary cutting boards fit together within said primary cutting board and are completely covered by said primary cutting board in order to be not visible;

6. The set of nested cutting boards of claim 1 wherein:
said primary, secondary, and tertiary cutting boards can be any shape;

7. The set of nested cutting boards of claim 1 wherein:
said set of nested cutting boards look like only one board ;

8. A set of nested cutting boards comprising:
a set of at least two cutting boards configured to fit within one another;
a primary cutting board configured to allow a smaller secondary cutting board to be inserted within a cavity in said primary cutting board;
said secondary cutting board when inserted within said cavity is completely covered on all sides and not visible;
said secondary cutting board if desired can be configured to allow another tertiary cutting board to be inserted within a cavity in said secondary cutting board;
said tertiary cutting board when inserted within said cavity in secondary cutting board is completely covered on all sides and not visible;
said primary cutting board configured to allow said secondary cutting board including said tertiary cutting board to be inclusively inserted into a cavity within said primary cutting board.

9. The set of nested cutting boards of claim 8 wherein:
when said secondary cutting board and said tertiary cutting board are nested together the said tertiary cutting board is not visible.

10. The set of nested cutting boards of claim 8 wherein:
when said secondary cutting board and said tertiary cutting board are nested together and inclusively nested within the said primary cutting board said secondary and said tertiary boards are not visible.

11. The set of nested cutting boards of claim 8 wherein:
said set of nested cutting boards looks like one individual cutting board;

12. The set of nested cutting boards of claim 8 wherein:
said set of nested cutting boards does not take up more space than the said primary cutting board.
